(19) United States
(12) Patent Application Publication
(10) Pub. No.: US 2003/0222782 A1
(43) Pub. Date: Dec. 4, 2003

(54) Method and apparatus for pool alarm system

(76) Inventor: Sylvain Gaudreau, Prevost (CA)

Correspondence Address: OGILVY RENAULT, 1981 MCGILL COLLEGE AVENUE, SUITE 1600, MONTREAL, QC, H3A2Y3, CA

(21) Appl. No.: 10/160,021

(22) Filed: Jun. 4, 2002

(51) Int. Cl. G08B 23/00

(52) U.S. Cl. 340/573.6

(57) ABSTRACT

a pool alarm system in combination with a swimming pool comprising: a detection mechanism for detecting intrusion into the pool and generating a detection output signal; a first alarm receiving the detection output signal and sounding the first alarm; a timer circuit triggered by the first alarm and generating a timer exceeded output signal after a predetermined time has lapsed; a second alarm receiving the timer exceeded output signal and sounding the second alarm; and a stop mechanism to shut off the first alarm and the second alarm; wherein the first alarm is a local alarm to be heard by people inside or around the pool and the second alarm is a general alarm to be heard by surrounding neighbors. Also described is a method for detecting intrusion in a swimming pool comprising: activating a first low-level intensity alarm to alert a person in the pool without disrupting a surrounding area; providing a stop mechanism manually accessible near an edge of the swimming pool for deactivating the first alarm; activating a second higher-level intensity alarm to alert the surrounding area if the first alarm has not been deactivated within a predetermined time following its activation.

### FIELD OF THE INVENTION

The invention relates to a pool alarm system. More specifically, it relates to a pool alarm system with multiple alarm levels that and a deactivation button.

### BACKGROUND OF THE INVENTION

Pool alarm systems are known in the prior art. Some systems are made to detect when a person immersed in a body of water has stopped breathing. Others are made to detect when a person in a body of water is in danger by monitoring body movements. Yet others are attached directly to a person or child and are activated when they enter the water.

Most current pool alarm systems have many drawbacks. False alarms are often a problem for the types of systems that detect disturbances in the water. Strong winds, heavy rain, or an object falling in the water tend to set off the alarm. Others, such as that described in U.S. Pat. No. 6,064,309 to Sellers et al., require a person to wear a particular article on their body, the article equipped with a radio frequency transmitter and a water sensor in order to activate an alarm when the person enters the water. This system can only detect the presence of those wearing the article.

U.S. Pat. No. 5,019,802 to Brittain et al. describes a system that can detect an intrusion of a child within an area of the swimming pool, before the child actually falls in. The system is enabled and disabled with a code on a keypad, so that only those who know the code can disable the alarm. A disadvantage to this is that a code can easily be forgotten or not passed on to other adults using the pool. Furthermore, if the code is not entered to enable the alarm, then no alarm will sound if a child falls into the water. For example, if an adult disables the alarm to swim and exits the water to go answer the phone inside, it is possible that this person will not take the time to enable the system before entering the house, leaving the pool unattended and the system vulnerable to not detecting a drowning child.

Moreover, since it is essential to provide a system that will be fool proof, there is a need for a system that does not suffer of the many drawbacks of the prior art.

### SUMMARY OF THE INVENTION

Accordingly, an object of the present invention is to provide a pool alarm system that is easy to install and use.

Another object of the present invention is to provide a pool alarm system that can alert a wide area of the neighborhood when someone is in danger.

A further object of the present invention is to provide a pool alarm system that will be effective in dangerous situations and not susceptible to false alarms.

Yet another object of the invention is to provide a pool alarm system that automatically returns to an enabled state after being disabled.

According to a first broad aspect of the present invention, there is provided a pool alarm system in combination with a swimming pool comprising: a detection mechanism for detecting intrusion into the pool and generating a detection output signal; a first alarm receiving the detection output signal and sounding the first alarm; a timer circuit triggered by the first alarm and generating a timer exceeded output signal after a predetermined time has lapsed; a second alarm receiving the timer exceeded output signal and sounding the second alarm; and a stop mechanism to shut off the first alarm and the second alarm; wherein the first alarm is a local alarm to be heard by people inside or around the pool and the second alarm is a general alarm to be heard by surrounding neighbors.

Preferably, the system is located at an edge of the swimming pool, the stop mechanism is manually accessible by a swimmer from within the swimming pool, and the detection mechanism is a sonar transducer.

Also preferably, the system comprises a third alarm that is connected to a residential alarm system and can send an emergency signal to either a central watch center or the police. Flashing and revolving lights can also be connected to the third alarm to help locate the swimming pool with the drowning person in the neighborhood. The third alarm can also be connected to a very high intensity audio alarm that alerts a wide area of the danger.

According to a second broad aspect of the present invention, there is provided a method for detecting intrusion in a swimming pool comprising: activating a first low-level intensity alarm to alert a person in the pool without disrupting a surrounding area; providing a stop mechanism manually accessible near an edge of the swimming pool for deactivating the first alarm; activating a second higher-level intensity alarm to alert the surrounding area if the first alarm has not been deactivated within a predetermined time following its activation.

Preferably, the system works in two modes of operation: watch and standby. The system is in watch mode when the pool is empty and the detection apparatus is scanning the pool for human presence. When someone jumps or falls into the pool, a first low-level alarm is activated. If the person in the water is not in danger, the system is easily deactivated by pressing a button on the device attached to the side of the pool. The system then goes into standby mode until a human presence is no longer detected in the water. Once the person exits the water, the device allows a fixed amount of time to elapse and returns to watch mode.

Also preferably, a distinctive sound is provided for the audio alarms and neighbors are alerted of the installation of a pool alarm system.

### BRIEF DESCRIPTION OF THE DRAWINGS

These and other features, aspects and advantages of the present invention will become better understood with regard to the following description and accompanying drawings wherein:

FIG. 1 is a preferred embodiment of the detecting unit;

FIG. 2 is a block diagram of the pool alarm system;

FIG. 3 is a state diagram of the system.

### DETAILED DESCRIPTION OF THE PREFERRED EMBODIMENT

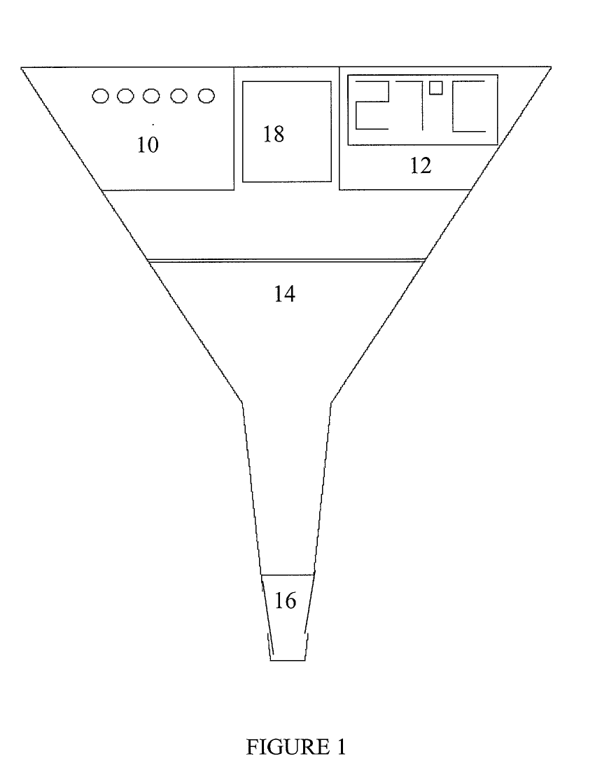

FIG. 1 is the preferred embodiment of the detection apparatus used in the system of the present invention. The housing comprises a lower portion immersed in the water and an upper portion above the water. The lower portion detects a presence in the water by emitting a sound wave and receiving the reflection of the emitted sound wave. The bottom portion of the detection apparatus is an ultrasonic transducer 16 that converts the received sound waves into electrical signals. These electrical signals are processed to determine if something or someone is in the water. The processor monitors the received sound waves to detect a change in the sound wave that indicates the presence of a person.

Line 14 of the detection apparatus is the range within which the water level should be. The device should be placed so that the water level is approximately half way up the white portion of the housing. The upper portion comprises the stop button 18. This button disables the alarm and places the system in standby mode. In the upper corner of the detection apparatus, the outside temperature is displayed 12. A series of LEDs 10 indicate the state of the device.

A control unit 32 is placed near the pool and may comprise a configuration panel or board used to setup the system. Several outputs are present on the control unit and are used to connect the control unit to the detection apparatus as well as other external accessories. A 24V ac battery is used to power the detection apparatus, therefore conforming to Canadian and American regulations.

The detecting unit 34 is attached to the side of a swimming pool. The device is activated once at the beginning of the summer and shut down at the end of the summer. The activation is done with a special key that turns it on. The installation is easily done by an adult by placing the detection apparatus at a predetermined location on the side of the swimming pool and connecting it to the control unit. The control unit needs to be connected to a 120 V ac outlet. In order to attach it to the residential alarm system, this must be done with the participation of the home alarm system company that will add a defined zone for your pool alarm system. There should not be any additional costs.

The device is always on and does not require any further adjustments once it has been activated. Its initial mode of operation is watch mode. This means the device is constantly sending out sound waves and analyzing the reflected waves to determine if someone is in the pool. Upon detection of a human in the water, a first low-level alarm is heard. This first level alarm is asking the person in the water if they are in danger. If the person in the water is not in danger, the stop button is pressed and the device goes into standby mode. The device continues to emit sound waves and analyze the reflecting waves to determine if the person is still in the water. More people can enter the water without there being a change in the status of the device. As long as at least one person remains in the water, the device remains in standby mode. If everybody exits the water, the device no longer senses the presence of a person in the water. After a fixed amount of time has elapsed, for example thirty seconds, the device automatically returns to watch mode. If only one person was present in the water and this person has exited the water temporarily, for example to jump off the diving board, they have thirty seconds to re-enter the water while the device is still in standby mode. If the thirty seconds elapse before the person re-enters the water, the device has exited the standby mode and entered the watch mode. Therefore, upon detection of the person in the water again, the low-level intensity audio alarm will sound asking the person if he or she is in danger. The stop button must be pressed again for the device to return to standby mode.

A person has a fixed amount of time to respond to the low-level intensity audio alarm, for example fifteen seconds. If the stop button has not been pressed within the fifteen seconds, a second higher intensity audio alarm is activated. This alarm is louder in order to alert a wider area of the presence of a person in the water that may be in danger. This second level alarm can also be deactivated by pressing on the stop button. This would cause the device to enter the standby mode.

If the second level alarm is not responded to within a fixed amount of time, for example fifteen seconds, a third alarm is activated. This third alarm is a very high level intensity sound that indicates that a person is in danger. The third alarm can be directly linked to a residential alarm system and send an emergency signal through the telephone network. This signal could be monitored by 911, for example. A drowning code could sent to the police. The emergency signal could also be sent to a central monitoring station that would send an emergency vehicle to the location of the alarm. A signal could also be sent to the home owner's cell phone to indicate that someone may be in danger in the pool.

An optional external accessory is a lighting system that can be activated at the same time as the third alarm. Flashing or revolving lights can be used to help neighbors pinpoint the exact location where someone may be in danger.

The system is effective against children accidentally falling into the swimming pool. An adult around the pool, inside the house, or in the surrounding neighborhood is immediately alerted of the presence of someone in the swimming pool.

The alarm is not activated by wind or heavy rain in the pool, often the cause of false alarms in other pool alarm systems, nor is it sensitive to objects such as balls falling into the water.

The method of detection using the sonar transducer is done in the following way. When the system is installed, an initialization process is required. A sound wave is emitted when the pool is empty of people. The wave is reflected at the back end of the pool and received by the transducer. The reflected wave is transformed into an electrical signal. The electrical signal is then analyzed. The material on which the signal reflects determines many properties of the received wave. Its amplitude, for example, varies depending on the material on which it reflects. In some cases, there is more absorption of the signal whereas in other cases, there is less absorption. During the initialization process, the system determines the amplitude of the signal that is reflected and retains that parameter in memory. During the detection process, the reflected signal is analyzed and its amplitude is compared to the amplitude of the initialization signal. If the amplitude is outside a selected range, this registers as an intrusion in the pool and a detection output signal is sent to the first alarm.

Humans reflect sound waves within a distinct range. By adding a second transducer to emit and receive sound waves, it is possible to compare the amplitudes of the reflected waves and detect only human intrusion into the pool. This will avoid setting off the alarm when using a robot to clean the pool. A user will then be able to set an automatic pool cleaner on without having to turn the alarm system off.

The detecting unit is placed on the side of the pool such that the transducer is 12 inches from the surface of the water. The signal has a 5° range with 2.5° above the central axis and 2.5° below the central axis. The intensity of the signal is adjusted such that it will reach its peak at a distance that is sufficiently far away from the surface of the water so as to not detect objects floating on the surface of the water.

The sounds used for the audio alarms are distinctive from standard car and home alarms. The instruction manual accompanying the system strongly recommends a home owner to advise the immediate neighbors about the installation of a pool alarm system and allow them to sample the distinctive sounds in order for them to recognize them when necessary.

Preferably, the three audio alarms are distinct from one another, with the loudest of the three being the most alarming and effective.

As soon as the presence of a human is no longer detected, the alarm will stop, no matter what level of alarm is sounding. Alternatively, a visual alarm can be connected to the system, to alert someone who is in an isolated room such as a basement or a garage, for example, that someone may be in danger in the swimming pool.

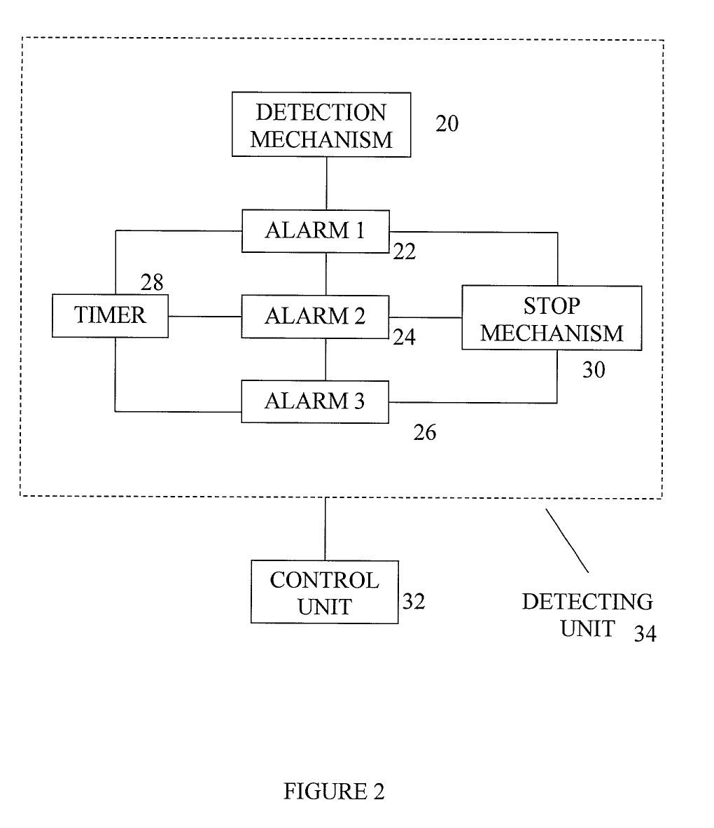

FIG. 2 shows a block diagram of the system. The detecting unit 34 comprises several modules. A detection mechanism 20, which is preferably a sonar transducer, is connected to a first alarm 22. A detection output signal is sent from the detection mechanism 20 to the first alarm 22 when detection occurs. The first alarm 22 is triggered and sounds a low level alarm that can be heard by people in and around the pool. A signal is then sent from the first alarm to a timer circuit 28 to begin a timer countdown. A person in the pool can shut off the first alarm by activating the stop mechanism 30, preferably a button on the detecting unit. If the stop mechanism 30 is not activated before the timer countdown is exceeded, a second alarm 24 is triggered. This second alarm 24 is of higher intensity than the first alarm 22 and can be heard by surrounding neighbors.

Optionally, there can be a third alarm 26 in the detecting unit 34. Once the second alarm 24 is triggered, the timer circuit 28 is reset to begin another countdown. The time between the ringing of the second alarm and the ringing of the third alarm does not need to be the same as the time between the ringing of the first alarm and the ringing of the second alarm. These parameters are determined when the system is initialized at installation and can be modified at any time via the control unit. Once the second countdown has elapsed, a signal is sent to the third alarm 26 and a very high intensity alarm is activated. This alarm can be heard in the entire neighborhood.

The control unit 32 is connected to the detecting unit 34 via a wire. Optionally, a wireless connection may be used. A power supply is present in the control unit. Also present are a plurality of external connectors for connecting accessories. For example, a lighting or illumination system may be connected to the system via the control unit. A stroboscope light could be used and triggered when the third alarm is triggered. This would indicate the exact location of the swimming pool in the neighborhood to someone who heard the alarm but couldn't pinpoint where it was coming from. Another one of the connectors on the control unit can be used to connect the pool alarm system to the home alarm system. However, this connection could also be done using a Radio Frequency (RF) module in the control unit to avoid having excess wires between the home alarm system and the pool alarm. The control unit is connected to a central power unit for the house, ideally a 120 V ac outlet.

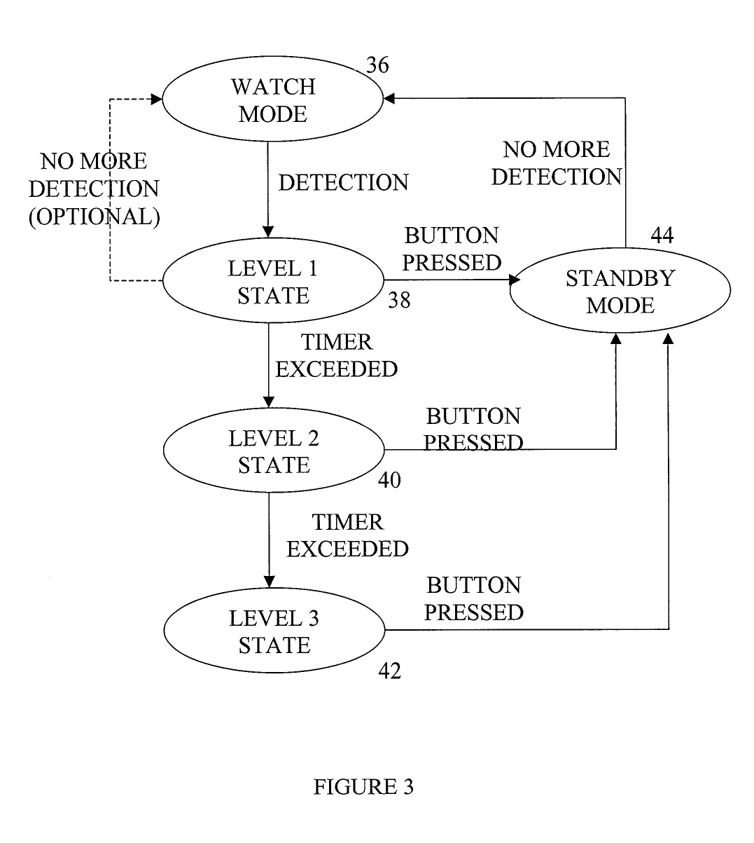

FIG. 3 is a state diagram of the system. The initial state is watch mode 36. In this state, the system is constantly sending out sound waves and analyzing the reflected waves to determine if there is an intrusion in the pool. If a detection occurs, the system goes into level 1 state 38. This means the first alarm is activated and ringing. If the stop button is pressed, the system enters standby mode 44. This means the system has been told that no one is in danger and there are swimmers in the pool. Detection continues while in standby mode 44 to ensure that swimmers are still in the pool. When the system detects that there is nobody left in the pool, a timer is triggered. Once the timer has elapsed and the system still detects no one in the pool, the system returns to watch mode 36. When the system is in level 1 state 38, a timer is triggered. If the timer exceeds before the stop button is pressed, the system enters level 2 40, which means a second alarm is activated. If the stop button is pressed, the system then goes into standby mode 44. The second alarm also activates a timer circuit. The duration of this countdown is longer than the other timers, such as 30 minutes. The second alarm rings for 30 minutes or until someone presses the stop button. If no one presses the button and the 30 minutes are exceeded, the second alarm shuts off. The system does not return into watch mode 36 until someone presses the button again.

Alternatively, the timer triggered by the second alarm can be of shorter length, such as 30 seconds, and once exceeded, a third alarm is triggered and the system goes into level 3 state 42. The third alarm can be shut off by pressing the stop button but if not, it will ring for approximately 30 minutes and stop ringing. The system will not return to watch mode 36 or standby mode 44 by itself after the third alarm has rang. It will wait for someone to press the stop button before returning to standby mode.

Also alternatively, the system can be designed to detect momentary intrusion. This means that once the system has entered level 1 38, it will keep detecting to determine if the intruder is still in the pool. If the system no longer detects an intrusion while still in level 1 38, it returns to watch mode 36 without needing the stop button to be pressed.

Another option on the system is to include a counter. The system can be set to trigger the first alarm only after repeated detection. This is useful to avoid false alarms. For example, if the counter is set to three, the system will trigger the first alarm only after it has detected intrusion on three consecutive reflected waves. Alternatively, the system can trigger the first alarm only after it has detected intrusion on three reflected waves within a limited time frame. The system could also be set to trigger the first alarm after more or less than 3 detections.

The detecting unit 34 comprises a series of Light Emitting Diodes (LED) 10 to indicate the state in which the system is. For example, a first LED would indicate watch mode, a second LED would indicate Standby mode, a third LED would indicate whether the system is on or off, and a fourth LED would indicate a state of alarm. This LED could be activated when the system is enters level 1, level 2, and level 3. After the third alarm has shutoff because the timer has been exceeded, this LED would remain on to show the owner that the alarm system went off and no one pressed the button.

Yet another option is to have a second detecting unit in the case of oddly shaped pools. If the entire area of the pool is not covered by one detecting unit, additional detecting units can be installed and connected to the same control unit.

The detecting unit 34 is made such that the Printed Circuit Board (PCB) with all of its components such as a microprocessor chip and others are well protected by epoxy. All of the connectors are also well protected by the epoxy to ensure that there is no contact with the water. This ensures the protection of the swimmers against electric shocks as well as the well-functioning of the system.

It will be understood that numerous modifications thereto will appear to those skilled in the art. Accordingly, the above description and accompanying drawings should be taken as illustrative of the invention and not in a limiting sense. It will further be understood that it is intended to cover any variations, uses, or adaptations of the invention following, in general, the principles of the invention and including such departures from the present disclosure as come within known or customary practice within the art to which the invention pertains and as may be applied to the essential features herein before set forth, and as follows in the scope of the appended claims.

What is claimed is:

1. A pool alarm system in combination with a swimming pool comprising:
a detection mechanism for detecting intrusion into the pool and generating a detection output signal;
a first alarm receiving said detection output signal and sounding said first alarm;
a timer circuit triggered by said first alarm and generating a timer exceeded output signal after a predetermined time has lapsed;
a second alarm receiving said timer exceeded output signal and sounding said second alarm; and
a stop mechanism to shut off said first alarm and said second alarm;
wherein said first alarm is a local alarm to be heard by people inside or around the pool and said second alarm is a general alarm to be heard by surrounding neighbors.

2. A combination as claimed in claim 1, wherein said system is located at an edge of said swimming pool.

3. A combination as claimed in claim 2, wherein said stop mechanism is manually accessible by a swimmer from within said swimming pool.

4. A combination as claimed in claim 1, wherein said detection mechanism is a sonar transducer.

5. A combination as claimed in claim 1, further comprising a third alarm, wherein said timer circuit is triggered by said second alarm and generates a second timer exceeded output signal to trigger said third alarm, and said third alarm is a very loud alarm to be heard in a wide area.

6. A combination as claimed in claim 5, wherein said third alarm is connected to a residential alarm system to transmit through a telephone line an emergency signal.

7. A combination as claimed in claim 6, wherein said third alarm is connected to a lighting system to indicate the location of the swimming pool in the neighborhood, said lighting system triggered by said second timer exceeded output signal.

8. A combination as claimed in claim 1, wherein said system further comprises a water level indicator to indicate the positioning of said system with respect to the water in the swimming pool.

9. A combination as claimed in claim 8, wherein said system further comprises a temperature indicator to indicate the outside temperature.

10. A combination as claimed in claim 8, wherein said system further comprises a plurality of Light Emitting Diodes to indicate the state of the system.

11. A combination as claimed in claim 1, further comprising a counter to be decremented by said detection mechanism each time a detection occurs, said counter triggering said first alarm.

12. A combination as claimed in claim 1, further comprising a second detection mechanism to be placed within the same pool.

13. A combination as claimed in claim 6, further comprising a radio frequency module to communicate between said pool alarm system and said residential alarm system.

14. A method for detecting intrusion in a swimming pool comprising:
activating a first low-level intensity alarm to alert a person in the pool without disrupting a surrounding area;
providing a stop mechanism manually accessible near an edge of said swimming pool for deactivating said first alarm;
activating a second higher-level intensity alarm to alert said surrounding area if said first alarm has not been deactivated within a predetermined time following its activation.

15. A method as claimed in claim 14, further comprising activating a third alarm connected to a residential alarm system and capable of sending an emergency signal through a telephone network, said third alarm activated if the second alarm has not been deactivated within a predetermined time following its activation.

16. A method as claimed in claim 15, wherein said third alarm further comprises an audio alarm of louder intensity than said second high-level alarm.

17. A method as claimed in claim 15, further comprising activating an illumination device to alert a large surrounding area of the location of the swimming pool with someone in danger, said illumination device activated in conjunction with said third alarm.

18. A method as claimed in claim 14, further comprising providing an alarm sound distinctive from car alarms and home alarms.

19. A method as claimed in claim 14, further comprising alerting neighbors of the presence of a detection apparatus in the swimming pool.

20. A method as claimed in claim 14, further comprising providing two modes of operation: standby and watch, watch mode when detecting intrusion into the pool and standby mode while people are swimming safely in the pool.

21. A method as claimed in claim 20, further comprising exiting watch mode and entering standby mode after the stop mechanism has been activated.

22. A method as claimed in claim 21, further comprising exiting standby mode and entering watch mode a predetermined amount of time after a presence is no longer detected in the swimming pool.
